(19) United States
(12) Patent Application Publication
(10) Pub. No.: US 2015/0066745 A1
(43) Pub. Date: Mar. 5, 2015

(54) PAYMENT RELAY SYSTEM AND METHOD

(71) Applicant: UBGreen CO., LTD, Seoul (KR)

(72) Inventor: Wang-Ju Lee, Seoul (KR)

(73) Assignee: UBGreen CO., LTD, Seoul (KR)

(21) Appl. No.: 14/129,763

(22) PCT Filed: Oct. 24, 2012
(86) PCT No.: PCT/KR2012/008774

§ 371 Date: Dec. 27, 2013

(30) Foreign Application Priority Data
May 11, 2012 (KR) 10-2012-0050385

(51) Int. Cl. G06Q 20/38; G06Q 20/22; G06Q 20/32; H04L 29/06; H04L 29/08

(52) U.S. Cl. CPC G06Q 20/385; H04L 63/08; H04L 67/10; G06Q 20/3223; G06Q 20/227
USPC 705/39

(57) ABSTRACT

A payment relay system according to the present disclosure may allow even a PG server, which is unable to access (use) account information or card information, to process a payment for a cost and a wire transfer by using a key value of an online ID, which substitutes for a bank account or a credit card, and is configured in a form of file or by a combination of numbers and characters. Also, the payment relay system can also minimize a separate change or the demand on devices for processing such payment manner.

### TECHNICAL FIELD

The present disclosure relates to a payment relay system and method, and more particularly, a payment relay system and method, capable of providing an online ID which is used by a user of a mobile terminal (or a portable terminal) as a substitute for a credit card or a bank account, relaying financial transactions and transfers between mobile terminals using the online ID, and facilitating commodity and financial transactions in a mobile environment.

### BACKGROUND ART

With development of mobile terminals, the mobile terminals which have been limited to voice calls and web access are used for executing fundamental financial payments by accessing a dedicated terminal.

In recent times, a mobile terminal is used for paying for a cost in convenience stores and shops, in which a dedicated terminal is installed, using a built-in chip issued from a bank. However, payable costs are limited and the payment cannot be executed in a place without the dedicated terminal. Also, it is difficult to immediately handle a wire transfer (an account transfer or merely a transfer) and a payment for a cost (payment or cost payment) upon a general commercial transaction merely using the chip built in the mobile terminal.

Payment gateway companies in Korea, except for financial institutions such as banks and credit card companies, are difficult to directly access users' account information or card information. Hence, the payment in a mobile environment is carried out using a USIM chip for user authentication or a built-in card in a mobile terminal, which has been authenticated by a financial institution. It has been well known that the chip or card is useable only in stores having dedicated readers and actually used merely to supplement card transactions using credit cards or cash transactions within a range without exceeding a predetermined upper limit. For such system, only one credit card is allowed for use. For example, when the one credit card is different from a credit card to which a high discount rate is applied in a specific store or shopping mall, the one credit card is unable to have the discount advantage. That is, only the credit card built-in the mobile terminal may be limitedly used.

Accordingly, this applicant desires to propose a payment relay system which is widely used in various financial transactions, which allows PG companies to use card transactions and wire transfers without using users' real account numbers and card information, and by which many sheets of credit cards or account numbers (hereinafter, referred to as ‘multi-card’) can be selectively used, if necessary, for increasing user convenience.

### DISCLOSURE OF THE INVENTION

Therefore, to obviate those problems, an aspect of the detailed description is to provide a payment relay system, in which an online ID corresponding to a credit card or bank account of a mobile terminal user is provided for the terminal user to perform general commercial transactions, wire transfers (an account transfer, a credit transfer or merely a transfer) and various types of financial transactions, by way of selecting one of various credit cards issued by various credit card companies or various bank accounts issued by various banks, if necessary, without exposing financial information.

To achieve these and other advantages and in accordance with the purpose of the present invention, as embodied and broadly described herein, there is provided a payment relay system including a financial institution registration module that is configured to register, for payment, financial institution information including a card company name or a bank name and a card name or a bank account name of a user of a mobile terminal, and phone information on the mobile terminal, an access relay module that is configured to provide the mobile terminal with an interface screen, on which a list of cards or bank accounts useable for payment is displayed for user selection, and an access path toward a card company or bank selected by the user, when the mobile terminal logs in for the payment, and an online ID management module that is configured to request for card information related to an online ID having a specific key value, corresponding to one selected credit card or bank account, from a financial institution server of the selected card or bank account, and acquire the key value of the online ID generated in the financial institution server in response to the request, when the one credit card or bank account is selected by the user of the mobile terminal from the list of cards or bank accounts displayed on the interface screen.

The access relay module may allow the mobile terminal to substitute the online ID for one of the credit card and the bank account to execute the payment through the access path provided.

Here, the online ID management module may provide the corresponding financial institution server with the card company or bank account selected by the user of the mobile terminal and the user phone information or login information, and request for issuing a one-off online ID for acquisition.

In such a manner, in the aspect that the plurality of cards are used in one card company and a plurality of bank accounts are used in one bank, various cards of a corresponding card company for each of various card companies and various bank accounts of a corresponding bank of various banks, namely, a multi-card or a multi-account can be used, thereby increasing user convenience. Also, without using information on a credit card itself, security can be enhanced.

Also, since the mobile terminal does not have to use any card information or bank account information, a problem of an illegal use of cards or bank accounts cannot be caused even if the mobile terminal is lost.

Preferably, the financial institution server may store the information provided from the online ID management module and information related to the generated one-off online ID in a matching manner.

More preferably, the financial institution server may invalidate the issued online ID when the issued one-off online ID is not used for payment for more than a predetermined time.

Accordingly, in addition to the enhancement of the security due to the use of the online ID card, time-based security can also be enhanced, which may result in enhancement of security of an entire system.

By the use of the online ID for each of various card companies or banks or each of cards or bank accounts of those card companies or banks in a distinguishing manner, a conventional problem of needing to take a certificate for each card or bank or individually using a specific chip can be overcome. Consequently, the use of multi-card or multi-account can be simply implemented without employing a device or equipment therefor, and a further addition of other cards or bank accounts can be facilitated.

In accordance with another preferred embodiment of the detailed description, there is provided a payment relay system including a financial institution registration module that is configured to register, for payment, financial institution information including a card company name or a bank name and a card name or a bank account name of a user of a mobile terminal, and phone information on the mobile terminal, an online ID management module that is configured to provide the financial institution information to financial institution servers of the card companies or banks registered in the financial institution registration module, request for generating a plurality of online IDs, which match the plurality of registered cards or bank accounts, respectively, and acquire the requested online IDs for storage, and an access relay module that is configured to provide the mobile terminal with an interface screen, on which a list of cards or bank accounts useable for payment is displayed for user selection, and an access path toward a card company or bank selected by the user, when the mobile terminal logs in for the payment, wherein the access relay module may select an online ID stored in such a manner of matching one selected card or bank account, when the one card or bank account is selected by the user of the mobile terminal from the list of cards or bank accounts displayed on the interface screen, and the mobile terminal may substitute the online ID for one of the card and the bank account to execute the payment through the access path provided.

The financial institution server may store the information provided from the online ID management module and information related to the generated online ID in the matching manner.

The financial institution server may update the generated online ID information at a predetermined period and provide the updated online ID information to the online ID management module.

In such a manner, in the aspect that the plurality of cards are used in one card company and a plurality of bank accounts are used in one bank, various cards of a corresponding card company for each of various card companies and various bank accounts of a corresponding bank of various banks, namely, a multi-card or a multi-account can be used, thereby increasing user convenience. Also, without using information on a credit card itself, security can be enhanced.

In addition to the enhancement of the security due to the use of the online ID card, time-based security can also be enhanced, which may result in enhancement of security of an entire system. By the use of the online ID for each of various card companies or banks or each of cards or bank accounts of those card companies or banks in a distinguishing manner, a conventional problem of needing to take a certificate for each card or bank or individually using a specific chip can be overcome. Consequently, the use of multi-card or multi-account can be simply implemented without employing a device or equipment therefor, and a further addition of other cards or bank accounts can be facilitated.

The user mobile terminal may provide the phone number related thereto or login information to a recipient mobile terminal, to which a cost is to be transferred, at the moment of paying for the cost.

Also, the recipient mobile terminal may request for the payment by providing the phone number or the login information provided from the user mobile terminal, and member store information pre-stored therein, to the financial institution server through the access relay module.

The user mobile terminal may include a near field communication (NFC) chip for short range wireless communication, and use the NFC chip to provide the phone number of the user mobile terminal or the login information upon performing the login to the recipient mobile terminal, to which the cost is to be transferred, in a wireless manner.

The recipient mobile terminal may be a card reader. The card reader may request for the payment by providing the phone number of the user mobile terminal or the login information, a member store code allocated thereto, member store information, and information on the cost to be paid, to the financial institution server through the access relay module.

Therefore, the payment can be executed simply by the same conventional method as the use of a credit card, namely, by approaching the mobile terminal to the card reader of a member store, which may result in an increase in user convenience.

To achieve these and other advantages and in accordance with the purpose of the present invention, as embodied and broadly described herein, there is provided a payment relay method including an information registering step of storing and registering financial institution information including a card company name or bank name and a card name or bank account name, associated with a user of a mobile terminal, and user login information or phone information of the mobile terminal matched with the financial institution information, an information receiving step of receiving the phone information from the user mobile terminal, a list displaying step of displaying on the mobile terminal a list of financial institution information registered in the matching manner with the received phone number, a card selecting step of determining whether or not a card name or a bank account name to be used is selected from the list displayed in the list displaying step, a card information generation requesting step of requesting for generating online ID card information from a financial institution server of a financial institution corresponding to the card name or bank account name selected in the card selecting step, a card information receiving step of receiving the generated online ID information from the financial institution server, a payment information receiving step of receiving payment information related to a cost to be paid from the user mobile terminal, and a payment processing step of processing the payment by sending the cost to be paid, received in the payment information receiving step, and the online ID information, received in the card information receiving step, to the financial institution server.

The payment processing step may be configured to process the payment using a card or bank account which matches the online ID information received from the financial institution server.

The online ID may be invalidated when the payment is completed or is not executed for more than a predetermined time.

In such a manner, in the aspect that the plurality of cards are used in one card company and a plurality of bank accounts are used in one bank, various cards of a corresponding card company for each of various card companies and various bank accounts of a corresponding bank of various banks, namely, a multi-card or a multi-account can be used, thereby increasing user convenience. Also, without using information on a credit card itself, security can be enhanced.

Also, since the mobile terminal does not have to use any card information or bank account information, a problem of an illegal use of cards or bank accounts cannot be caused even if the mobile terminal is lost.

In addition to the enhancement of the security due to the use of the online ID card, time-based security can also be enhanced, which may result in enhancement of security of an entire system. By the use of the online ID for each of various card companies or banks or each of cards or bank accounts of those card companies or banks in a distinguishing manner, a conventional problem of needing to take a certificate for each card or bank or individually using a specific chip can be overcome. Consequently, the use of multi-card or multi-account can be simply implemented without employing a device or equipment therefor, and a further addition of other cards or bank accounts can be facilitated.

In accordance with another preferred embodiment of the detailed description, there is provided a payment relay method including an information registering step of storing and registering financial institution information including a card company name or bank name and a card name or bank account name, associated with a user of a mobile terminal, and user login information or phone information of the mobile terminal matched with the financial institution information, an online ID generation requesting step of providing the financial institution information and the phone information to financial institution servers of the card companies or banks registered in the information registering step to request for generating a plurality of online IDs for the plurality of registered cards or bank accounts, respectively, a card information receiving step of receiving information related to the plurality of online IDs generated in the generation requesting step, an information receiving step of receiving the phone information from the user mobile terminal, a list displaying step of displaying on the mobile terminal a list of financial institution information registered in the matching manner with the phone information received in the information receiving step, a card selecting step of determining whether or not a card name or bank account name to be used is selected from the list displayed in the list displaying step, a payment information receiving step of receiving payment information related to a cost to be paid from the user mobile terminal, a card determining step of determining an online ID matched with the card name or bank account name, selected in the card selecting step from the list of cards or bank accounts, and a payment processing step of processing the payment by sending the online ID determined in the card determining step, and the payment information, to the financial institution server of the selected card company or bank.

In the online ID generation requesting step, the financial institution server may store the information related to the online IDs generated for the plurality of cards, and the phone information in a matching manner.

The financial institution server may update the generated online ID information at a predetermined period and provide the updated online ID information.

In such a manner, in the aspect that the plurality of cards are used in one card company and a plurality of bank accounts are used in one bank, various cards of a corresponding card company for each of various card companies and various bank accounts of a corresponding bank of various banks, namely, a multi-card or a multi-account can be used, thereby increasing user convenience. Also, without using information on a credit card itself, security can be enhanced.

In addition to the enhancement of the security due to the use of the online ID, time-based security can also be enhanced, which may result in enhancement of security of an entire system. By the use of the online ID for each of various card companies or banks or each of cards or bank accounts of those card companies or banks in a distinguishing manner, a conventional problem of needing to take a certificate for each card or bank or individually using a specific chip can be overcome. Consequently, the use of multi-card or multi-account can be simply implemented without employing a device or equipment therefor, and a further addition of other cards or bank accounts can be facilitated.

### Advantageous Effect

In accordance with the detailed description, upon purchasing goods or services using a mobile terminal, a cost may be paid to a recipient (another party or a seller), who provides such goods or services, using the terminal.

A multi-card or multi-account function, which may be used by selecting one of various credit card companies and selecting one of credit cards of the selected credit card company or selecting one of various banks and selecting one of various bank accounts of the selected bank, may be provided, for example, a credit card to which a high discount rate is applied may be used for a service to be paid, resulting in an increase in user convenience.

An addition of a separate device for implementing the multi-card or multi-account function can be minimized, with facilitating a further addition of other credit cards or bank accounts.

A terminal user may carry out financial transactions even without exposure of financial information, and a payment can be executed conveniently even without a construction of a separate system.

Also, unlike the related art system in which a payment system of a terminal, such as the conventional PC, a notebook or a tablet PC, is different from a payment system of a mobile terminal (portable terminal), such as a cellular phone or a smart phone, a single system may simply allow for payment even in the terminal like the PC as well as the mobile terminal.

Also, for a wire transfer (a credit transfer or an account transfer), a recipient may simply receive a cost, which has been deposited in a virtual account, into his or her real account without a construction of a separate system.

In addition, the single system may also be applicable to a non-faced payment, such as a payment in an online open market or an online transfer, as well as a face-to-face payment which the user has to directly carry out.

### BRIEF DESCRIPTION OF THE DRAWINGS

FIG. 1 is a connection conceptual view schematically illustrating a payment relay system in accordance with one exemplary embodiment;

FIG. 2 is a connection conceptual view schematically illustrating a payment relay system in accordance with another exemplary embodiment;

FIG. 3 is a connection conceptual view schematically illustrating a payment relay system in accordance with another exemplary embodiment;

FIG. 4 is a connection conceptual view schematically illustrating a payment relay system in accordance with another exemplary embodiment;

FIG. 5 is a connection conceptual view schematically illustrating a payment relay system in accordance with another exemplary embodiment;

FIG. 6 is a connection conceptual view schematically illustrating a payment relay system in accordance with another exemplary embodiment;

FIG. 7 is a reference view for one example of executing a wire transfer using the payment relay system;

FIG. 8 is a reference view for another example of executing an account transfer using the payment relay system; and

FIG. 9 is a block diagram of a payment relay system in accordance with one exemplary embodiment.

### MODES FOR CARRYING OUT THE PREFERRED EMBODIMENTS

The following description will be given, before explaining the present disclosure.

A financial institution server disclosed herein may be a card company server, a bank server, a wireless carrier (telecommunications firm) server, a payment gateway (PG) server, a value added network (VAN) server and other various types of banking sector servers. The financial institution server may also be referred to as the card company server, the bank server, the wireless carrier server, the PG server and other banking sector servers. The financial institution server in the exemplary embodiments of the present disclosure disclosed herein will be described based on one of a card company server or a bank server.

A mobile terminal disclosed herein refers to a terminal which can request for a payment by accessing the financial institution server via a network and receive a payment result therefrom. The mobile terminal disclosed herein may be a PC, a smart tap, a cellular phone, a PDA, a smart phone, a notebook computer, and any other type which can support wireless communication during movement.

A cost payment (or a payment) disclosed herein may be provided from a side which acquires goods or services to a side which provides the goods or services. Here, the request for the payment may be transferred from the mobile terminal directly to the financial institution server or from a card terminal (reader), which executes short range wireless communication with the mobile terminal, to the financial institution server.

An online ID disclosed herein may be generated and issued by a financial institution, specifically, a card company or a bank, in response to a request by a relay system. The online ID may substitute for a bank account or a credit card of a mobile terminal user. In addition to the banks or card companies, the online ID may be used for allowing a financial institution, such as a PG company which executes business for financial transactions, to relay a payment or a transfer. The online ID may have a form of file, or may have a form of a specific key value in an environment of the present disclosure. Here, the key value may have a form that characters, numbers and specific symbols are selectively combined. The same key value may not be preferably existent in terms of being used for financial payments. Also, the online ID and the key value with respect to the online ID may be considered as the same and thus the terms will be used together. The online ID and the key value may not be distinguished over each other because they play the same role regardless of having the form of file or the combination of number and character strings.

Here, the online ID is an ID that a user requests from the relay system so as to use services using the online ID. When the user registers in the relay system credit card companies to use, credit cards of those credit card companies, banks, account numbers of those banks, telecommunications firms and the like, the relay system may request for issuing online IDs from financial institution servers of the corresponding credit card companies, banks or telecommunications firms, and store information on the issued online IDs to be used for payment.

That is, when the user logs in the relay system, the relay system may provide a user terminal with a list of credit card companies, credit cards of those credit card companies, banks, account numbers of those banks, and telecommunications firms, which have already been registered. When the user selects a credit card, a bank account or a telecommunications firm from the provided list, the relay system may send an online ID which matches the selected credit card, bank account or telecommunications firm to the financial institution server, such that the financial institution server can use the selected online ID for payment.

This may allow a credit card, selected from various credit cards of various credit card companies (here, even the same credit card company provides various types of credit cards), to be identified and used for payment. For example, even if one smart phone application is installed, various credit cards or bank accounts can be selectively used and thus a multi-card or a multi-account can be used. That is, such system may allow for distinguishing different credit card companies or banks and for selectively using credit cards or bank accounts of those credit card companies or banks. Here, when a telecommunications firm is selected, the system may also be used for a conventional service that a cost used for a micropayment is added to a phone bill.

Here, when the same online ID is continuously used, docking or hacking may occur in the financial institution server. Therefore, it may be preferable to update the issued online ID at a predetermined period and provide the updated online ID to the relay system, thereby improving security.

Meanwhile, according to another preferred embodiment, when the user selects a specific credit card or bank account from the provided list, the relay system may request for generating and issuing an online ID from a financial institution server of the selected credit card or bank account, so as to acquire a one-off online ID.

Such system may highly improve security in the aspect that the relay system does not have to manage many online IDs. The system may also allow for use of multi-card or multi-account by virtue of identifying selected credit cards, which are selected from various credit cards of various credit card companies (even the same credit card company provides various credit cards) for use in payment, for example, selecting for use various credit cards or bank accounts, if necessary, even if one smart phone application is installed. That is, by this system, various credit card companies or banks may be distinguished and several credit cards or bank accounts of those credit card companies or banks may be selected for use.

Here, the security may preferably be enhanced by limiting a period for which a generated online ID is valid. For example, online ID information generated is available for one minute and becomes invalid when the generated online ID information has not been used or fedback to a financial institution server for the one minute.

The mobile terminal disclosed herein may be provided with a near field communication (NFC) chip embedded therein. The embedded NFC chip may perform short range wireless communication and perform data communication in case of coming in contact with a card reader or being located adjacent to the card reader within a short distance. The mobile terminal may also provide, directly to the card reader, login information related to the mobile terminal and a password or information related to a phone number of the mobile terminal itself.

In the present disclosure, a card company server and a PG/VAN server are disclosed separately. However, the current trend is that the PG server and the VAN server are incorporated into the card company server. It should first be understood in this specification that the PG server or the VAN server is referred to as a PG/VAN server and the function of the PG/VAN server may be included in the card company server. It may also be possible in this specification that the relay system is constructed to play a role of the PG/VAN server.

A card company disclosed herein refers to a credit card company, and a server which is operated in the card company for expenditure is referred to as a card company server.

Hereinafter, the present disclosure will be described in detail with the accompanying drawings.

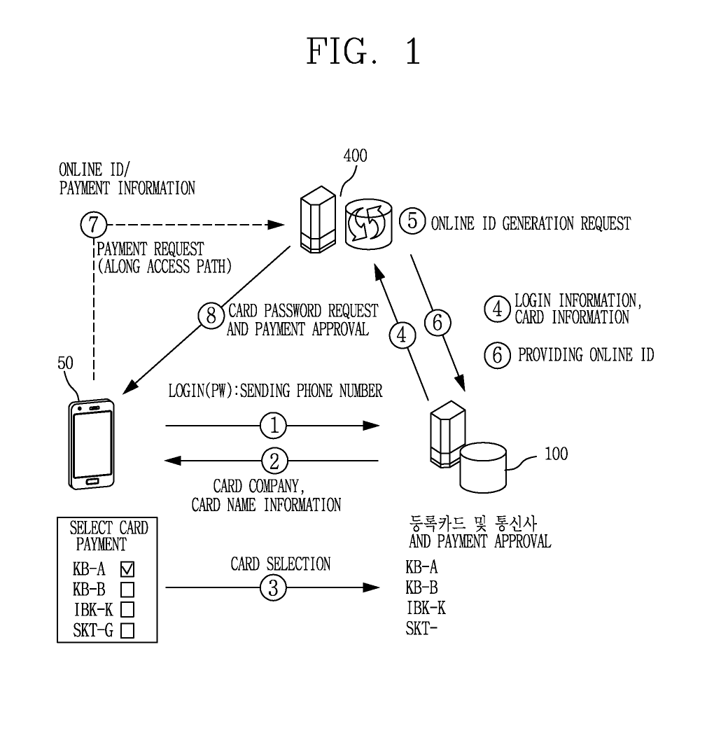

FIG. 1 is a connection conceptual view schematically illustrating a payment relay system in accordance with one exemplary embodiment.

As illustrated in FIG. 1, when a user's mobile terminal 50 of a side which pays for a cost logs in a payment relay system 100, the relay system 100 may provide an interface to the mobile terminal such that the mobile terminal 50 can select a card company and a credit card of the card company or a bank and a bank account, which is to be used for the payment, and also provide an access path toward a card company for using a card company and a credit card selected by the mobile terminal 50.

Here, financial institution information which includes the card company, the credit card of the card company, the bank and the bank account, is information which is being actually used by the user or is to be used by the user. It may be preferable to previously store the financial institution information by subscribing a service that the relay system 100 provides, in such a manner of matching the financial institution information with user's login information or a phone number of a user's mobile terminal.

Here, the relay system 100 may request for a generation of a one-off online ID, which is to be used by the user of the mobile terminal 50, from a financial institution server 400 of a bank or card company, which has been selected by the user from a plurality of card companies or banks, and acquire the requested generated one-off online ID.

The online ID may be an ID that the user of the mobile terminal 50 requests in advance from a bank or a card company for use. The online ID, which is invented by this applicant, may be used for a mobile financial payment even in an area in which other financial institutions (for example, a PG company) except for banks or card companies are forbidden from using bank account information or card information.

The online ID may have a form of a file or a key value which is formed by a combination of number strings and character strings. The online ID may have a specific key value but the very online ID may not have information related to an account number or a credit card. On the other hand, the online ID may correspond to one bank account or credit card in a bank or card company. To this end, the user of the mobile terminal 50 should apply in advance for a payment service provided by the relay system 100 and also apply in advance for use of the online ID to the bank or card company. In turn, the bank or card company may provide the relay system 100 with an online ID, which is generated to match a credit card selected by the user of the mobile terminal 50 and login information or phone information.

When the user logs in the relay system 100 and selects a specific credit card or bank account through an interface provided, the relay system 100 may request for issuing a one-off online ID from the corresponding financial institution server, acquire the issued one-off online ID, and provide an access path toward the corresponding financial institution server for payment.

Here, more preferably, the financial institution server 400 may enhance security by invalidating the one-off online ID when the payment is completed using the one-off online ID or the one-off online ID has not been used for more than a predetermined time.

Consequently, the mobile terminal 50 may merely generate an event signal, such as a payment processing request, without being provided with the acquired online ID. When the event request is received, the relay system 100 may allow the payment to be carried out using an online ID which matches login information or a phone number. This may prevent an external exposure of card information and the like due to a loss of the mobile terminal, and accordingly enhance security. Here, for a mobile terminal having a phone number, such as a smart phone or a cellular phone, the phone number may play a role of an identifier of the mobile terminal. For a terminal without a phone number, such as a PC or the like, login information may play a role of an identifier of the terminal or a phone number may be used by being entered by the user upon logging in the terminal. Upon receiving a request for generating and providing an online ID from the relay system 100, a financial institution server may generate an online ID to match the phone number or the login information and provide the generated online ID to the relay system 100.

Even in this case, a mobile terminal having a phone number may be constructed such that login information is further used to function as an identifier.

Therefore, the user of the mobile terminal 50 may use the online ID like a credit card or a bank account. Here, the user of the mobile terminal 50 may pay for a cost using the online ID or undergo a process of entering a password, similar to a typical security authentication, upon performing a wire transfer.

When the mobile terminal 50 logs in the relay system 100, the relay system 100 may provide an interface for the mobile terminal 50 to select a card company and a credit card to be used for payment. When the mobile terminal 50 selects a card company and a credit card, the relay system 100 may request for generating an online ID from a financial institution server 400 corresponding to the selected card company and acquire the online ID. The financial institution server 400 may match the generated online ID (or a key value, omitted hereinafter) with a credit card, a phone number or login information. The mobile terminal 50 may request for a payment by providing payment information, which includes a cost to be paid, to the financial institution server 400 using the online ID by referring to an access path provided by the relay system 100. The financial institution server 400 may request for a password with respect to a credit card to be used for the payment and carry out a payment process.

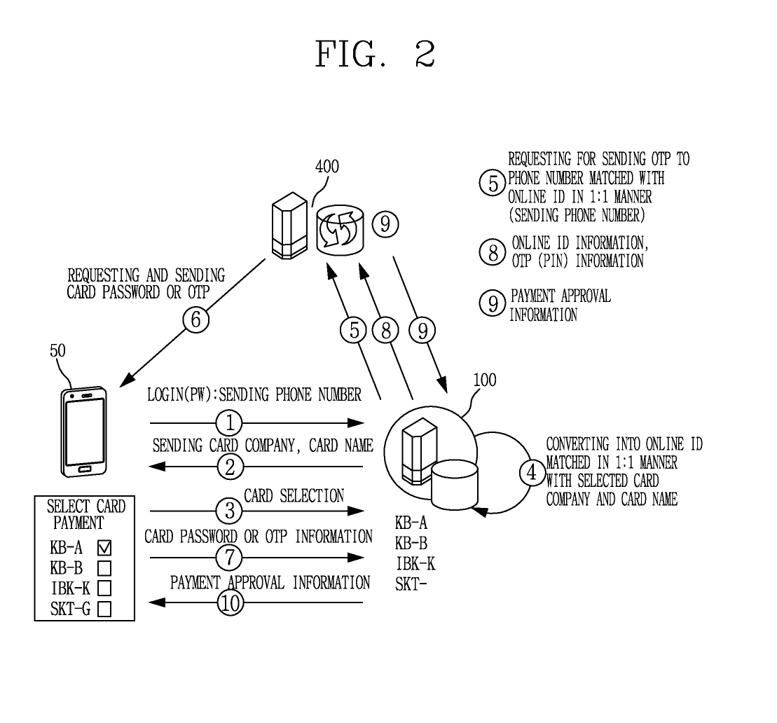

Meanwhile, FIG. 2 is a connection conceptual view schematically illustrating a payment relay system in accordance with another exemplary embodiment. Unlike the system and method illustrated in FIG. 1, in which when one card or bank account is selected from a list provided on a user mobile terminal, the relay system requests for issuing a one-off online ID from a financial institution server of a corresponding financial institution for use, the exemplary embodiment of FIG. 2 illustrates a system and method of requesting, from each financial institution, for an online ID with respect to each of a plurality of cards and bank accounts, which have been registered by a user in advance, and storing those online IDs in a relay system for use.

Hereinafter, a payment relay system and method according to another exemplary embodiment will be described with reference to FIG. 2.

When a user registers in advance a plurality of card companies, cards, banks and bank accounts to be used, the relay system 100 may request for generating online IDs by providing the user-registered cards or bank accounts, and phone information including login information or a phone number to respective financial institution servers 400, and acquire the generated online IDs. The acquired online IDs may then be stored in the relay system 100 in a matching manner.

Here, the respective financial institution servers 400 may preferably store the generated online IDs to match the respective cards or bank accounts.

Accordingly, when a plurality of cards are registered on the card company basis or a plurality of bank accounts are registered on the bank basis, a plurality of online IDs may be issued even for the same card company or bank. That is, when a card (bank account) as a subordinate concept is provided in plurality for a card company (bank) as a superordinate concept, an online ID may be generated for each subordinate concept in a one-to-one (1:1) matching manner for storage.

When the user registers in advance financial institution information, which includes a card company name or a bank name and a card name or a bank account name to be used by the user, and phone information including login information or a phone number, the relay system 100 may provide the phone information to a corresponding financial institution server 400 to request for an online ID for acquisition.

Afterwards, when the user logs in the relay system 100 using the mobile terminal 500 for paying for a cost, the relay system 100 may display a list of pre-registered financial institution information on the user mobile terminal 50 and output an interface screen for the user to select one to use.

When one card or bank account to be used is selected from the user mobile terminal 50, the relay system 100 may provide corresponding online ID information, phone information and information related to a cost to be paid, involved in the payment, to the financial institution server 400 of a card company or bank corresponding to the card or bank account, which has been registered in such a manner of matching the card or bank account selected from the plurality of online IDs previously stored. The financial institution server 400 may then perform the payment using a real card or bank account which matches the online ID provided by the relay system 100.

Here, in order to enhance security, the financial institution server 400 may preferably perform the payment by request for inputting a one time password (OTP) or a password to the phone number of the phone information provided by the relay system 100.

Consequently, the mobile terminal 50 may merely generate an event signal, such as a payment processing request, without being provided with the acquired online ID. When the event request is received, the relay system 100 may allow the payment to be carried out using an online ID which matches login information or a phone number. This may prevent an external exposure of card information and the like due to a loss of the mobile terminal, and accordingly enhance security. Here, for a mobile terminal having a phone number, such as a smart phone or a cellular phone, the phone number may play a role of an identifier of the mobile terminal. For a terminal without a phone number, such as a PC or the like, login information may play a role of an identifier of the terminal or a phone number may be used as an identifier by being entered by the user upon logging in the terminal. Upon receiving a request for generating and providing an online ID from the relay system 100, a financial institution server may generate an online ID to match the phone number or the login information and provide the generated online ID to the relay system 100.

Even in this case, a mobile terminal having a phone number may be constructed in such a manner that login information is further used to function as an identifier.

Therefore, the user of the mobile terminal 50 may use the online ID like a credit card or a bank account.

More preferably, the financial institution server 400 may update the plurality of online IDs stored when more than a predetermined time lapses, and provide the updated online IDs to the relay system 100, thereby enhancing security.

In the relay system and method illustrated in FIGS. 1 and 2, without processing merely using the phone number of the mobile terminal, an one-off online ID may be issued or an online ID may be issued for each card or bank account as a subordinate concept, such that plural cards or bank accounts can all be used on one application when there are the plurality cards or bank accounts (multi-card or multi-account) which are being used.

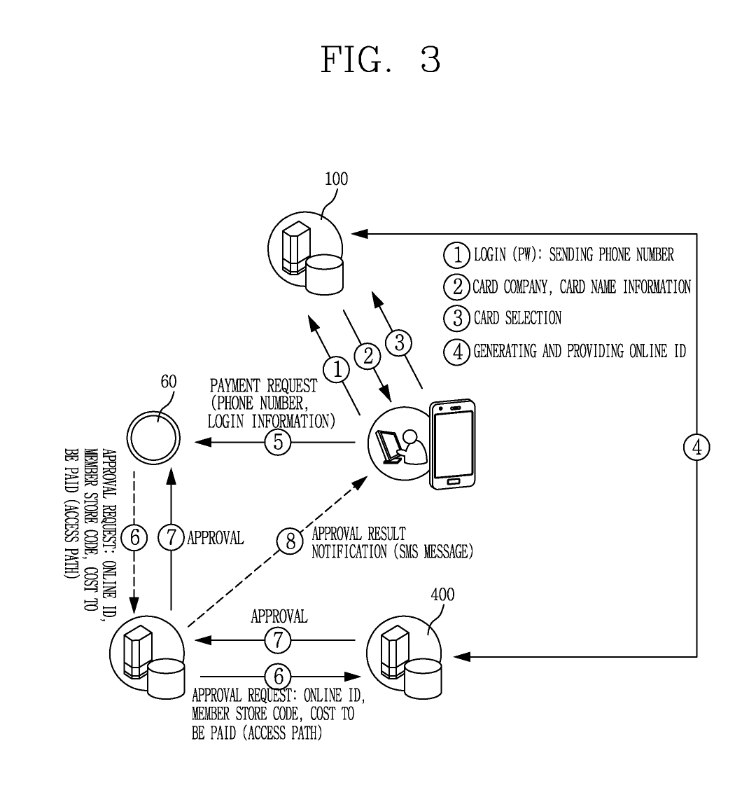

FIG. 3 is a connection conceptual view schematically illustrating a payment relay system in accordance with another exemplary embodiment.

A relay system and method illustrated in FIG. 3 is configured to solve a case when a payment is carried out between a user terminal 50 and a recipient terminal 60. The recipient terminal 60 may serve as the conventional card machine or reader installed in a restaurant or a shopping mall. FIG. 3 illustrates a system and method, in which the user mobile terminal 50 sends phone information to the recipient terminal 60, instead of information, such as credit card information or a digital certificate, and the recipient terminal 60 requests for a payment from the financial institution server 400 using the phone information through an access path provided by the relay system 100.

Such process will be described in detail with reference to FIG. 3.

The relay system 100 may store information related to a card company name, a card name according to the card company, a phone number of the mobile terminal 50, login information and an access path for each registered card name, all of which have been registered by the user of the mobile terminal 150 in advance. This process has been described in the exemplary embodiments of FIGS. 1 and 2, so detailed description thereof will be omitted.

When the mobile terminal 50 accesses and logs in the relay system 100, the relay system 100 may provide an interface such that the mobile terminal 50 can select a card company and a card, request for issuing a one-off online ID from the financial institution server 400 of a financial institution, which corresponds to the card or bank account selected by the user mobile terminal 50, and then acquire the issued online ID.

When the mobile terminal 50 accesses and logs in the relay system 100, the relay system 100 may provide only information related to the card company and the card to the mobile terminal 50. Here, in the mobile terminal may be installed an application (App), which displays the information related to the card company and the card provided by the relay system 100 for allowing a user selection.

The mobile terminal 50 may request for a payment from a terminal 60 of a recipient which sells goods or services and receives a corresponding cost. Here, the mobile terminal 50 may perform short range wireless communication through an NFC chip embedded therein, and provide the phone number or login information (phone information) of the user mobile terminal 50 to the payment terminal 60. The pieces or information may be encoded. The terminal 60 may send the phone number or login information and member store information (a member store name, a member store identification number or a member store code) to a PG/VAN server 300 through an access path provided by the relay system 100, so as to request for the payment.

Here, the pieces of information may be provided to the financial institution server 400 through a PG server or a VAN server. Hence, the PG server and the VAN server are referred to as a PG/VAN server 300 hereinafter.

When the payment terminal 60 requests for the payment from the PG/VAN server 300, the PG/VAN server 300 may request for the payment from the financial institution server 400 by providing the member store information, information related to a cost to be paid, received from the payment terminal 60, and information related to an online ID key value received from the relay system 100. The financial institution server (a card company server or a bank server) may search for a credit card or a bank account corresponding to the online ID key value and match them. When a correctly matched result is present, the financial institution server 400 may approve the payment with respect to the online ID. When the payment is approved by the financial institution server 400, the approval result may be notified to the mobile terminal 50. Here, the approval result may be provided in a form of short message service (SMS).

According to the payment method, security vulnerability of the mobile terminal 50 may be considerably overcome. The online ID itself may not include information related to any type of card or bank account. However, the online ID may have a similar characteristic to a reference number which is actually used for searching for a credit card or a bank account in a bank or a card company. Also, the payment terminal 60 may not require for hardware logic for providing the PG/VAN server 300 with a key value which is generated by numbers, characters, specific symbols or a selective combination of those numbers, characters and specific symbols. Since any separate component or device for providing the online ID key value to the PG/VAN server 300 is not needed, the payment terminal which has been used can be used as it is in the present disclosure.

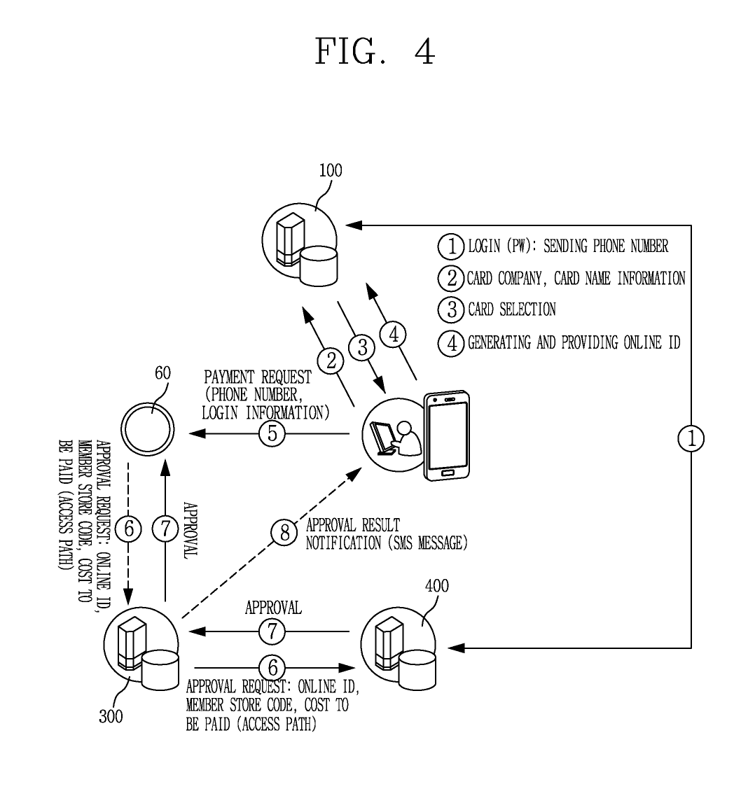

Meanwhile, unlike the exemplary embodiment of FIG. 3 illustrating that when an event with respect to a selection of a card or bank account to be used is generated in the user mobile terminal 50, a generation of a one-off online ID card is requested from a corresponding financial institution server for acquisition, an exemplary embodiment of FIG. 4 illustrates that an online ID card may be allocated in advance to each card or bank account as a subordinate concept so as to be used for payment.

As illustrated in FIG. 4, the relay system 100 may store information related to a card company name, a card name according to the card company, a phone number of the mobile terminal 50, login information and an access path for each registered card name, all of which have been registered by the user of the mobile terminal 50 in advance.

The relay system 100 may request for issuing online IDs for respective cards or bank accounts as a subordinate concept on the basis of each card company for registered cards or each bank for registered bank accounts, acquire the issued online IDs and store the acquired online IDs in such a manner of matching the acquired online IDs with phone information.

When the mobile terminal 50 accesses and logs in the relay system 100, the relay system 100 may provide an interface to the mobile terminal 50 such that the mobile terminal 50 can select a card company and a card. When the user mobile terminal 50 selects the card or bank account, an online ID card, which matches the selected card or bank account in a one-to-one (1:1) matching manner, may be selected (set or determined) among the plurality of online IDs.

When the mobile terminal 50 accesses and logs in the relay system 100, the relay system 100 may provide only information related to the card company and the card to the mobile terminal 50. Here, in the mobile terminal may be installed an application (App), which displays the information related to the card company and card provided by the relay system 100 for allowing a user selection.

The mobile terminal 50 may request for a payment from a terminal 60 of a recipient which sells goods or services and receives a corresponding cost. Here, the mobile terminal 50 may perform short range wireless communication through an NFC chip embedded therein, and provide the phone number or login information (phone information) of the user mobile terminal 50 to the payment terminal 60. The pieces or information may be encoded. The terminal 60 may send the phone number or login information and member store information (a member store name, a member store identification number or a member store code) to a PG/VAN server 300 through an access path provided by the relay system 100, so as to request for the payment.

Here, the pieces of information may be provided to the financial institution server 400 through a PG server or a VAN server. Hence, the PG server and the VAN server are referred to as a PG/VAN server 300 hereinafter.

When the payment terminal 60 requests for the payment from the PG/VAN server 300, the PG/VAN server 300 may request for the payment from the financial institution server 400 by providing the member store information, information related to a cost to be paid, received from the payment terminal 60, and information related to an online ID key value received from the relay system 100. The financial institution server (a card company server or a bank server) may search for a credit card or a bank account corresponding to the online ID key value and match them. When a correctly matched result is present, the financial institution server 400 may approve the payment with respect to the online ID. When the payment is approved by the financial institution server 400, the approval result may be notified to the mobile terminal 50. Here, the approval result may be provided in a form of short message service (SMS).

According to the payment method, security vulnerability of the mobile terminal 50 may be considerably overcome. The online ID itself may not include information related to any type of card or bank account. However, the online ID may have a similar characteristic to a reference number which is actually used for searching for a credit card or a bank account in a bank or a card company. Also, the payment terminal 60 may not require for hardware logic for providing the PG/VAN server 300 with a key value which is generated by numbers, characters, specific symbols or a selective combination of those numbers, characters and specific symbols. Since any separate component or device for providing the online ID key value to the PG/VAN server 300 is not needed, the payment terminal which has been used can be used as it is in the present disclosure.

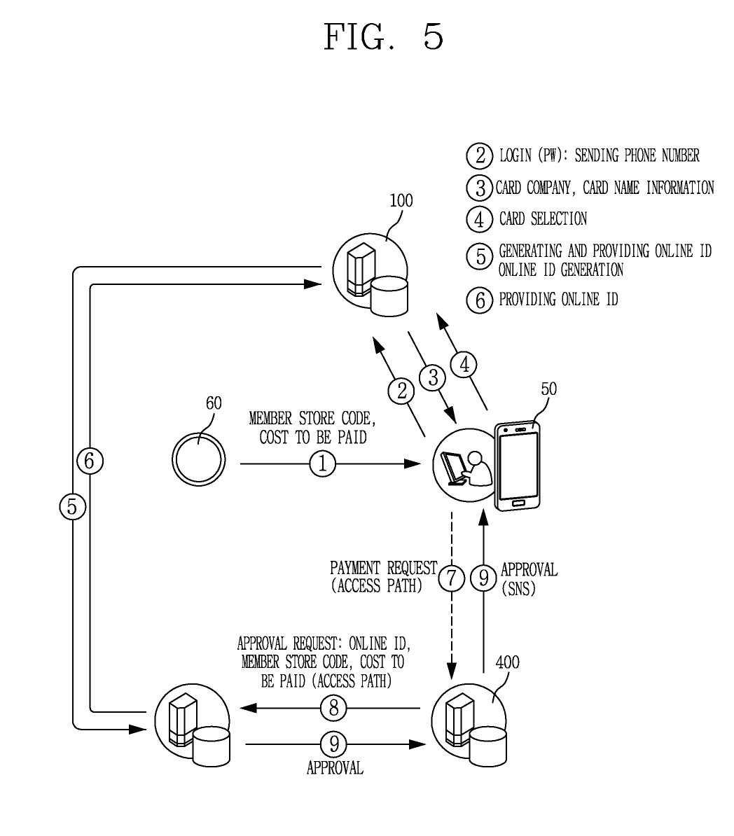

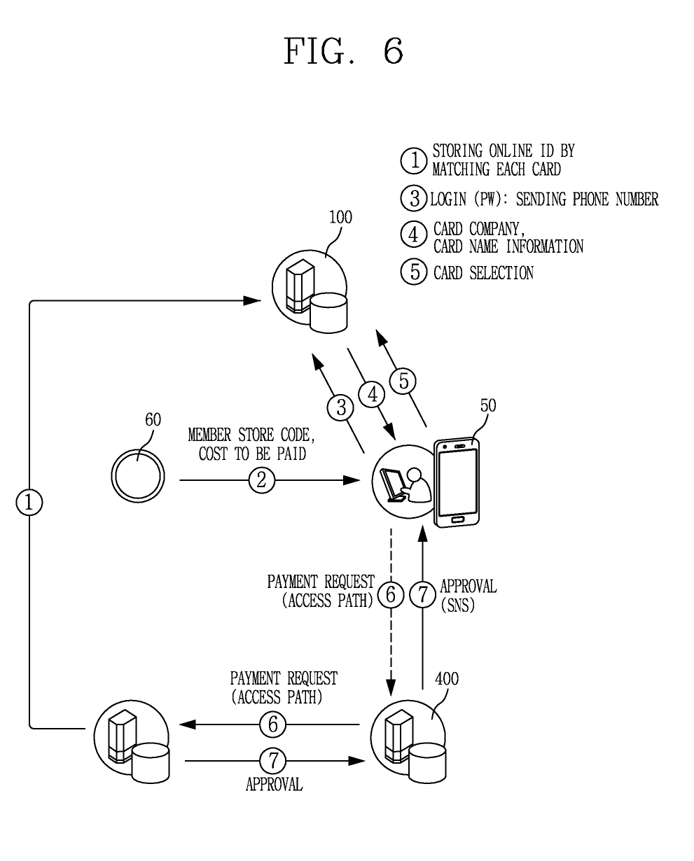

FIGS. 5 and 6 are connection conceptual views schematically illustrating a payment relay system in accordance with another exemplary embodiments.

The exemplary embodiments illustrated in FIGS. 3 and 4 are a process in which when the user mobile terminal 50 provides phone information to the recipient terminal 60 via short range communication, the recipient terminal 60 may perform a payment by providing member store information, information on a cost to be paid, and phone information to the financial institution server 400 through the relay system 100. However, the exemplary embodiments of FIGS. 5 and 6 illustrate a process, in which when the recipient terminal 60 provides member store information and information related to a cost to be paid to the user mobile terminal 50 via short range communication, the user mobile terminal 60 may carry out the payment. FIG. 5 illustrates a process using a one-off online ID (corresponding to the embodiment illustrated in FIG. 1) and FIG. 6 illustrates a process using an online ID card allocated to each card or bank account as a subordinate concept in advance (corresponding to the embodiment illustrated in FIG. 2).

Referring to FIG. 5, the mobile terminal 50 may carry out a payment by performing short range wireless communication with the payment terminal 60 of a cost recipient which provides goods or services. The recipient terminal 60 may provide member store information and a cost to be paid to the mobile terminal 50, and the mobile terminal may log in the relay system 100 to select a desired card company and a card according to the card company.

When the user mobile terminal 50 selects a card to be used for payment, the relay system 100 may provide information related to an access path to access the PG/VAN server 300, and request for issuing a one-off online ID from the corresponding financial institution server 400 for acquisition.

Here, the mobile terminal 500 may access the PG/VAN server 300 through the relay system 100 to provide the PG/VAN server 300 with member store information, a cost to be paid, and a key value of an online ID to request for paying for the cost.

The PG/VAN server 300 may provide the cost to be paid, the key value and the member store information to the financial institution server 400 (a card company server or a bank server) to request for the payment, and receive a payment approval result from the financial institution server 400 to provide to the mobile terminal 50. Here, the PG/VAN server 300 may notify the payment approval result to the mobile terminal 50 using a short message service (SMS).

The financial institution server 400 may receive the key value of the online ID provided by the PG/VAN server 300, and inquire (search for) a credit card or a bank account corresponding to the received key value. According to the inquiry, when there is the credit card or bank account corresponding to the key value, the financial institution server 400 may execute the payment with respect to the corresponding credit card or bank account.

Referring to FIG. 6, the relay system 100 may store information related to a card company name, a card name according to the card company, a phone number of the mobile terminal 50, login information and an access path for each registered card name, all of which have been registered by the user of the mobile terminal 50 in advance.

The relay system 100 may request for issuing online IDs for respective cards or bank accounts as a subordinate concept on the basis of each card company for registered cards or each bank for registered bank accounts, acquire the issued online IDs and store the acquired online IDs in such a manner of matching the acquired online IDs with phone information.

Afterwards, the relay system 100 may execute the payment by short range wireless communication with the payment terminal 60 of a cost recipient which provides goods or services. The recipient terminal 60 may provide member store information, and a cost to be paid to the mobile terminal 50, and in turn, the mobile terminal 50 may log in the relay system 100 to select a desired card company and a card according to the card company.

When the user mobile terminal 50 selects the card to be used for payment, the relay system 100 may provide information related to an access path to the PG/VAN server 300, and set (select, determine) an online ID which matches the selected card or bank account in a one-to-one correspondence.

Here, the mobile terminal 50 may access the PG/VAN server 300 via the relay system 100 and request for the payment by providing the member store information, the cost to be paid and a key value of the set online ID card.

The PG/VAN server 300 may request for the payment by providing the cost to be paid, the key value and the member store information to the financial institution server 400 (the card company server or the bank server), and receive a payment approval result from the financial institution server 400 to provide to the mobile terminal 50. Here, the PG/VAN server 300 may notify the payment approval result to the mobile terminal 50 using a short range service (SNS).

The financial institution server 400 may receive the key value of the online ID provided by the PG/VAN server 300, and inquire (search for) a credit card or a bank account corresponding to the received key value. According to the inquiry, when there is the credit card or bank account corresponding to the key value, the financial institution server 400 may execute the payment with respect to the corresponding credit card or bank account.

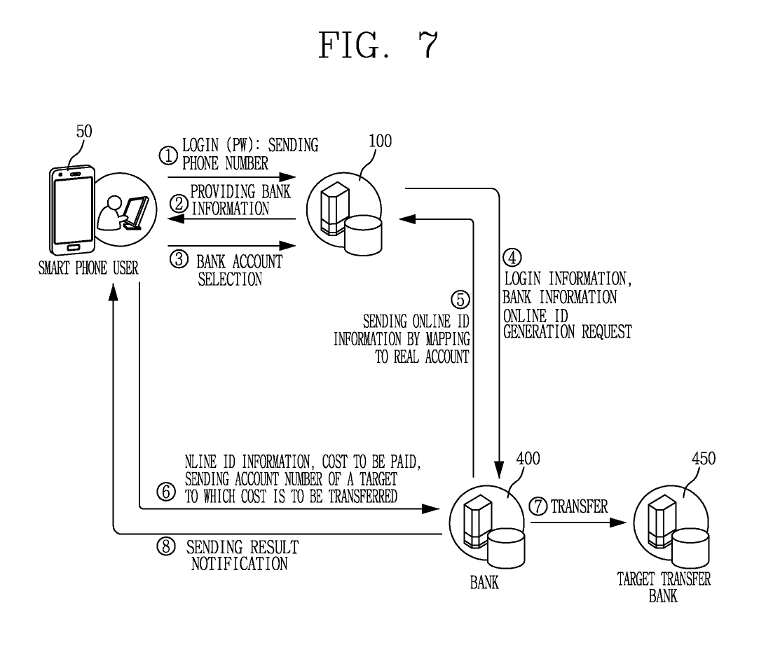

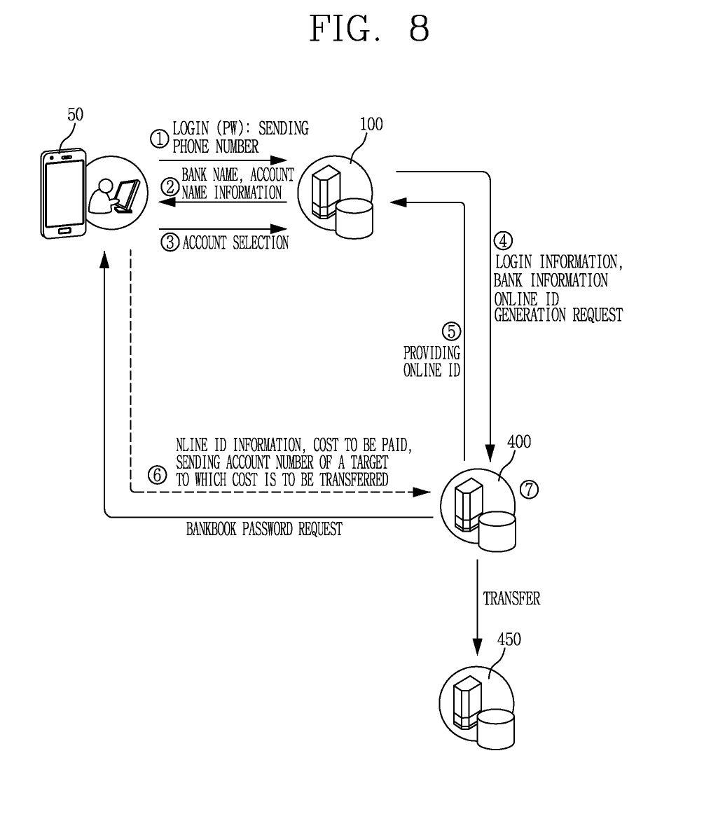

Meanwhile, the payment relay system illustrated in FIGS. 1 to 6 may also be used for wire transfer (a credit transfer or an account transfer), as well as financial transactions for goods or services. This will be described with reference to FIGS. 7 and 8.

FIG. 7 illustrates a reference drawing of one example of executing a wire transfer using the payment relay system.

Referring to FIG. 7, the mobile terminal 50 may log in the relay system 100 to request for a wire transfer service. The relay system 100 may provide an interface, through which bank and account information to which the wire transfer is executed is selectable. When a specific bank and a bank account to be used are selected in the mobile terminal 50, the relay system 100 may provide an access path toward the selected bank account to the mobile terminal 50. The user of the mobile terminal 50 may preferably register one or more than two bank accounts to use in the relay system 100 in advance.

When the user of the mobile terminal 50 is obviously aware of a target (object) to which the wire transfer is to be executed (or to which a cost is to be transferred), namely, a target transfer account and of the user's own account, an App installed in the mobile terminal 50 may access the financial institution server (or a bank server) 400 through the access path provided by the relay system 100. The App may then request for the wire transfer by providing the financial institution server 400 with a key value of an online ID, a cost to be paid and a target transfer account number through the access path provided by the relay system 100.

Here, the financial institution server 400 may search for a real account number corresponding to the key value of the online ID provided by the mobile terminal 50. According to the search result, when there is a real account corresponding to the key value of the online ID, the financial institution server 400 may set the cost to be transferred from the corresponding account. Afterwards, the financial institution server 400 may send an authentication code to the mobile terminal 50. The user of the mobile terminal 50 may then check the authentication number received, and feedback the checked result to the financial institution server 300 through the mobile terminal 50, thereby completing an authentication process for the mobile terminal 50.

Here, when a target bank to which the wire transfer is to be executed is a different bank (other than the same bank branch), the financial institution server 400 may execute depositing in the different bank, and request for a predetermined commission from a recipient (another user or a person) to whom a cost (money) is to be transferred or the user of the mobile terminal 50.

When the authentication process is completed, the financial institution server 400 may withdraw the cost from the real account corresponding to the key value of the online ID, and transfer the cost to the account number that the user of the mobile terminal 50 has selected. The financial institution server 400 may then notify the transfer result to the mobile terminal 50.

FIG. 8 illustrates a reference drawing of another example of executing a wire transfer using the payment relay system.

FIG. 8 is a reference drawing for explaining a process of executing a wire transfer when the user of the mobile terminal is not aware of a target transfer account number. When the user of the mobile terminal 50 requests for a transfer after logging in the relay system 100 and the relay system 100 provides an access path toward the financial institution server 400, the user of the mobile terminal 50 may access the financial institution server 400 through the access path, and then send a key value of an online ID for an authentication of the mobile terminal 50, a record of a cost to be paid, and a phone number of a target mobile terminal to which the cost is to be transferred.

The financial institution server 400 may generate a virtual account, which includes a key value of an online ID by which the user of the mobile terminal 50 is identified, a cost to be transferred, and information related to a recipient to whom the cost is to be transferred (for example, a phone number of the recipient), or search for an account number of the recipient, to whom the cost is to be transferred, by referring to the phone number of the recipient.

When a virtual account is generated, the phone number of the recipient to whom the cost is to be transferred may be considered as one account. When the recipient to whom the cost is to be transferred proves that he or she is an appropriate person to receive the transferred cost using his or her own phone number, the cost deposited in the virtual account may be paid to the recipient to whom the cost is to be transferred.

That is, when the virtual account is generated in the financial institution server 400, the relay system 100 may notify an event generation to the mobile terminal of the recipient to whom the cost is to be transferred. The recipient to whom the cost is to be transferred may log in the relay system 100 through the mobile terminal, and send his or her phone number. The relay system 100 may then provide an interface, through which the recipient can select bank and account number information to receive, to the mobile terminal of the recipient to whom the cost is to be transferred. When the recipient to whom the cost is to be transferred selects the bank and account information to receive, the relay system 100 may send the selected bank account information and the phone number of the recipient to whom the cost is to be transferred to the financial institution server 400, allowing for remittance by the financial institution server 400.

Here, the recipient to whom the cost is to be transferred may access the financial institution server 400 in an online manner to provide his or her phone number. When the financial institution server 400 sends an authentication code, the recipient to whom the cost is to be transferred may feedback the authentication code so as to prove that he or she is the person who receives the transferred cost. Or, the recipient to whom the cost is to be transferred may stop by an offline bank and provide an identification card and the mobile terminal so as to prove that he or she is the right person to receive the transferred cost, thereby receiving the cost transferred.

On the other hand, the financial institution server 400 may search for the recipient to whom the cost is to be transferred by inquiring the phone number of the recipient in a mobile telecommunication company server (not shown), and based on the search result, inquire an account in which the recipient receives the cost transferred.

Here, the financial institution server 400 may send a notice message to the phone number of the recipient to whom the cost is to be transferred to ask for a bank and an account number for receiving the cost transferred. Then, the financial institution server 400 may send an authentication code to the mobile terminal of the recipient to whom the cost is to be transferred to perform an authentication process.

When a target transfer bank is a different bank (other than the same bank branch), the financial institution server 400 may execute the transfer to the different bank, and request for a predetermined commission from the recipient to whom the cost is to be transferred or the user of the mobile terminal 50.

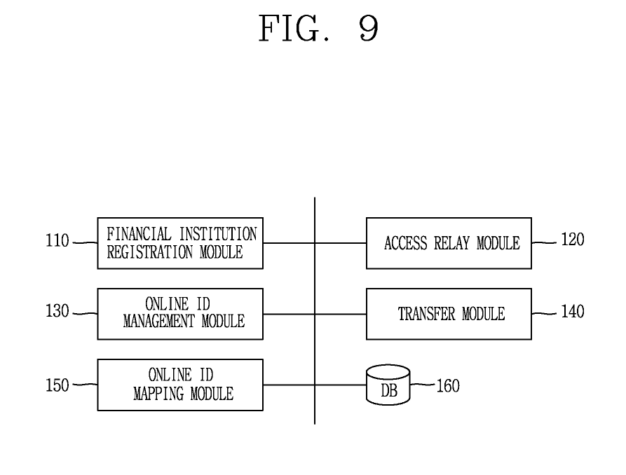

FIG. 9 is a block diagram of a payment relay system in accordance with one exemplary embodiment of the present disclosure.

As illustrated in FIG. 9, a relay system 100 may include a financial institution registration module 110, an access relay module 120, an online ID management module 130, a transfer module 140, an online mapping module 150, and a database 130.

The financial institution registration module 110 may be configured to register a card company name and a card name, which is to be used by a user who wants to pay for, and a mobile phone number, which is to be used by a user for the payment. The financial institution registration module 110 may register a side which executes a payment in the relay system 100. Since the payment is also executed when a seller and a purchaser are not clearly defined, anyone who takes part in the mobile transactions may preferably be registered.

The online ID management module 130 may access a server of a bank or a card company, request for generating an online ID of a user registered in the financial institution registration module 110, receive the generated online ID, and register the received online ID in the database 160. When the user executes a payment or a transfer, the online ID management module 130 may request for generating a key value of the online ID of the user of the mobile terminal 50 from the financial institution server 400. The key value of the online ID may not be provided to the mobile terminal 50. The user of the mobile terminal 50 may access the PG/VAN server 300 or the financial institution server 400 using the online ID key value along an access path provided, thereby executing the payment.

The transfer module 140 may provide a transfer service to the user of the mobile terminal 50. The transfer module 140 may request for a cost to be paid, a target transfer account, a phone number of a recipient, to whom the cost is to be transferred, from the user of the mobile terminal 150. Then, when the user of the mobile terminal 50 provides the pieces of information, the transfer module 140 may authenticate the user of the mobile terminal 50 and execute the cost transfer.

If a target account number to which the cost is to be transferred is uncertain, the transfer module 140 may generate the key value of the online ID or the phone number of the recipient, to whom the cost is to be transferred, as a virtual account number. Here, the transfer module 140 may inquire the mobile terminal of the recipient, to whom the cost is to be transferred, about a bank or account to which the cost is to be transferred, and authenticate the recipient using an SNS. When the authentication is completed, the transfer module 140 may provide the cost deposited in the virtual account to the recipient to whom the cost is to be transferred.

The online ID mapping module 150 may map a phone number of the user of the mobile terminal 50, card company information, and credit card information with the key value of the online ID. When the user of the mobile terminal 50 logs in to execute a payment and a transfer, the online ID mapping module 150 may record a history with respect to the payment or the transfer in the database 160. Afterwards, if a third party requests for an illegal payment by defrauding the key value of the online ID, it may be detected by comparison with the history recorded in the database 160.

The access relay module 130 may authenticate the mobile terminal 50 by referring to login information registered in the database 160 when the mobile terminal 50 logs in. Then, the access relay module 130 may provide an interface, through which the mobile terminal 50 can select financial institution information including a card company name and a card name, to the mobile terminal 50. Also, the access relay module 130 may provide an access path for a payment using a credit card selected by the user. The financial institution information provided by the access relay module 120 may be displayed on the mobile terminal 50. The mobile terminal 50 may thus select a desired card company and a card issued from the desired card company to use for payment.

The access relay module 120 may also generate the financial institution information in a form of webpage to provide to the mobile terminal 50. In this case, a separate App for displaying the financial institution information may not be required in the mobile terminal 50. The financial institution information generated in the form of webpage may be displayed on the mobile terminal 50. The user of the mobile terminal 50 may select a card company and a card to be used for payment, from those displayed card companies, thereby executing the payment.

The access relay module 120 may also provide the mobile terminal 50 with an access path toward a bank in case of a wire transfer between individual users, as well as processing the payment for goods or services in the mobile terminal 50.

[Description of reference numerals]

| | |
|---|---|
| 50: mobile terminal | 60: payment terminal |
| 100: relay system | 300: PG server |
| 400: financial institution server | |

1. A payment relay system comprising:
a financial institution registration module that is configured to register financial institution information including a card company name or a bank name and a card name or a bank account name of a user of a mobile terminal, and phone information matched with the financial institution information, the phone information including user login information or a phone number of the user mobile terminal;
an access relay module that is configured to provide the mobile terminal with an interface screen, on which a list of cards or bank accounts useable for a payment is displayed for user selection, and an access path toward a card company or bank selected by the user, when the mobile terminal logs in for the payment; and
an online ID management module that is configured to request for card information related to an online ID having a specific key value, corresponding to one selected credit card or bank account, from a financial institution server of the selected card or bank account, and acquire the key value of the online ID generated in the financial institution server in response to the request, when the one credit card or bank account is selected by the user of the mobile terminal from the list of cards or bank accounts displayed on the interface screen,
wherein the access relay module allows the mobile terminal to substitute the online ID for one of the credit card and the bank account to execute the payment through the access path provided.

2. The system of claim 1, wherein the online ID management module provides the corresponding financial institution server with the card company or bank account selected by the user of the mobile terminal and the user phone information or the login information, and requests for issuing a one-off online ID for acquisition.

3. The system of claim 2, wherein the financial institution server stores the information provided from the online ID management module and information related to the generated one-off online ID in a matching manner.

4. The system of claim 3, wherein the financial institution server invalidates the issued online ID when the issued one-off online ID is not used for payment for more than a predetermined time.

5. A payment relay system comprising:
a financial institution registration module that is configured to register financial institution information including a card company name or a bank name and a card name or a bank account name of a user of a mobile terminal, and phone information matched with the financial institution information, the phone information including user login information or a phone number of the user mobile terminal;
an online ID management module that is configured to provide the financial institution information and the phone information to financial institution servers of the card companies or banks registered in the financial institution registration module, request for generating a plurality of online IDs, which match the plurality of registered cards or bank accounts, respectively, and acquire the requested online IDs for storage; and
an access relay module that is configured to provide the mobile terminal with an interface screen, on which a list of cards or bank accounts useable for a payment is displayed for user selection, and an access path toward a card company or bank selected by the user, when the mobile terminal logs in for the payment,
wherein the access relay module selects an online ID stored in the matching manner with one selected card or bank account when the one card or bank account is selected by the user of the mobile terminal from the list of cards or bank accounts displayed on the interface screen, and the mobile terminal substitutes the online ID for one of the card and the bank account to execute the payment through the access path provided.

6. The system of claim 5, wherein the financial institution server stores the information provided from the online ID management module and information related to the generated online ID in the matching manner.

7. The system of claim 5, wherein the financial institution server updates the generated online ID information at a predetermined period and provides the updated online ID information to the online ID management module.

8. The system according to claim 1, wherein the user mobile terminal provides the phone number related thereto or login information to a recipient mobile terminal, to which a cost is to be transferred, at the moment of paying for the cost.

9. The system of claim 8, wherein the recipient mobile terminal requests for the payment by providing the phone number or the login information provided from the user mobile terminal, and member store information pre-stored therein, to the financial institution server through the access relay module.

10. The system of claim 9, wherein the user mobile terminal comprises a near field communication (NFC) chip for short range wireless communication, and uses the NFC chip to provide the phone number of the user mobile terminal or the login information upon performing the login to the recipient mobile terminal, to which the cost is to be transferred, in a wireless manner.

11. The system of claim 10, wherein the recipient mobile terminal is a card reader,
wherein the card reader requests for the payment by providing the phone number of the user mobile terminal or the login information, a member store code allocated thereto, member store information, and information on the cost to be paid to the financial institution server through the access relay module.

12. The system according to claim 1, wherein the user mobile terminal receives a member store code and information on the cost to be paid from the recipient mobile terminal, to which the cost is to be transferred, and
wherein the user mobile terminal requests for the payment by providing the received member store code, the information on the cost to be paid, and the online ID information acquired from the online ID management module, to the financial institution server through the access relay module.

13. A payment relay method comprising:
an information registering step of storing and registering financial institution information including a card company name or bank name and a card name or bank account name, associated with a user of a mobile terminal, and phone information matched with the financial institution information, the phone information including user login information or a phone number of the mobile terminal;
an information receiving step of receiving the phone information from the user mobile terminal;
a list displaying step of displaying on the mobile terminal a list of financial institution information registered in the matching manner with the received phone number;
a card selecting step of determining whether or not a card name or a bank account name to be used is selected from the list displayed in the list displaying step;
a card information generation requesting step of requesting for generating online ID card information from a financial institution server of a financial institution corresponding to the card name or bank account name selected in the card selecting step;
a card information receiving step of receiving the generated online ID information from the financial institution server;
a payment information receiving step of receiving payment information related to a cost to be paid from the user mobile terminal; and
a payment processing step of processing the payment by sending to the financial institution server the cost to be paid, received in the payment information receiving step, and the online ID information received in the card information receiving step.

14. The method of claim 13, wherein the payment processing step is configured to process the payment using a card or bank account which matches the online ID information received from the financial institution server.

15. The method of claim 13, wherein the online ID is invalidated when the payment is completed or is not executed for more than a predetermined time.

16. A payment relay method comprising:
an information registering step of storing and registering financial institution information including a card company name or bank name and a card name or bank account name, associated with a user of a mobile terminal, and phone information matched with the financial institution information, the phone information including user login information or a phone number of the mobile terminal;
an online ID generation requesting step of providing the financial institution information and the phone information to financial institution servers of the card companies or banks registered in the information registering step to request for generating a plurality of online IDs for the plurality of registered cards or bank accounts, respectively;
a card information receiving step of receiving information related to the plurality of online IDs generated in the generation requesting step;
an information receiving step of receiving the phone information from the user mobile terminal;
a list displaying step of displaying on the mobile terminal a list of financial institution information registered in a matching manner with the phone information received in the information receiving step;
a card selecting step of determining whether or not a card name or bank account name to be used is selected from the list displayed in the list displaying step;
a payment information receiving step of receiving payment information related to a cost to be paid from the user mobile terminal;
a card determining step of determining an online ID matched with the card name or bank account name, selected in the card selecting step from the list of cards or bank accounts; and
a payment processing step of processing the payment by sending the online ID determined in the card determining step, and the payment information to the financial institution server of the selected card company or bank.

17. The method of claim 16, wherein in the online ID generation requesting step, the financial institution server stores the information related to the online IDs generated for the plurality of cards, and the phone information in a matching manner.

18. The method of claim 16, wherein the financial institution server updates the generated online ID information at a predetermined period and provides the updated online ID information.
